(19) United States
(12) Patent Application Publication
(10) Pub. No.: US 2023/0088222 A1
(43) Pub. Date: Mar. 23, 2023

(54) SYSTEM AND METHOD FOR DYNAMICALLY SHAPING AN INTER-DATACENTER TRAFFIC

(71) Applicant: Flipkart Internet Private Limited, Bengaluru (IN)

(72) Inventors: V. Santhosh Kumar TANGUDU, Srikakulam (IN); Chaitanya GOYAL, Nabha (IN); Brijesh K. B, Bangalore (IN); Raghdipsingh Raghbirsingh PANESAR, Bangalore (IN); Krishna KUMAR, Bengaluru (IN); Nikhil AGRAWAL, Singrauli (IN)

(73) Assignee: Flipkart Internet Private Limited, Bengaluru (IN)

(21) Appl. No.: 17/949,006

(22) Filed: Sep. 20, 2022

(30) Foreign Application Priority Data
Sep. 21, 2021 (IN) 202141042711

(51) Int. Cl. H04L 47/2475; H04L 12/66; H04L 47/2408

(52) U.S. Cl. CPC H04L 47/2475; H04L 12/66; H04L 47/2408

(57) ABSTRACT

A system and method for dynamically shaping an inter-datacenter traffic. The method encompasses receiving, one or more inter-datacenter data packets of the inter-datacenter traffic, wherein each inter-datacenter data packet is associated with a corresponding application and/or application interaction. The method thereafter encompasses identifying, one or more target application flow policies for said each inter-datacenter data packet from one or more application flow policies pre-stored in one or more eBPF maps. The method thereafter leads to dynamically marking, a priority for said each inter-datacenter data packet using an eBPF XDP techstack, based at least on the identified one or more target application flow policies. Further the method encompasses transmitting to an edge router, said each inter-datacenter data packet with the corresponding marked priority. The method further comprises dynamically shaping via the edge router, the inter-datacenter traffic based on said each inter-datacenter data packet and said corresponding marked priority.

### TECHNICAL FIELD

The present invention generally relates to network traffic shaping and more particularly to systems and methods for dynamically shaping an inter-datacenter traffic based on dynamically marking of a priority for one or more inter-datacenter data packets of said inter-datacenter traffic using an eBPF (extended Berkeley Packet Filter) XDP (eXpress Data Path) techstack.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Over the past few years a number of digital applications are developed by various companies to provide various services to their customers. In order to provide efficient and effective services via these applications, it is required to optimize a bandwidth provided for transmission of data traffic associated with such applications. For instance, in large scale web companies, all user facing applications have to ensure high availability for smooth business operations, and millions of inter-datacenter data packets of these user facing applications are transmitted per second to execute various operations, therefore it is required to meet the bandwidth requirements for such user facing applications. The applications may be chosen by the companies to deploy in multi-datacenters (multi-zones) and operate in [Active-Active] mode or in [Active-Passive] mode depending on various requirements. The large scale web companies typically operate applications in the multiple datacenters (DCs) and transmission of a data of such applications from a source in one datacenter to a destination in another datacenter includes traversing multiple switches/routers located in these data centers. FIG. 1 depicts an exemplary traditional Leaf and Spine architecture where a data from a source [102] in a datacenter-1 to a destination [120] in a datacenter-2 moves in an order such that from the source [102] it moves to TOR switches [104], followed by POD level switches [106], super spine switches [108] and then moves to edge routers [110]. Thereafter, the data reaches other datacenter's (DC's) edge routers [112] using available inter-DC links. The data is then routed to the destination server [120] in the destination DC from the edge routers [112] through the super-spine switches [114], POD switches [116] and the TOR switches [118], respectively.

Furthermore, the multi-datacenter deployment of the applications leads to high number of interactions among the applications across the datacenters which implies high utilization of inter-DC bandwidth. Since the inter-DC bandwidth is limited it may get choked. The inter-datacenter (inter-DC) bandwidth cannot be scaled easily as it involves high costs and lead times. Hence, there is a need for a mechanism to manage the inter-datacenter bandwidth efficiently among the applications to provide a smooth experience to users. Also, the edge routers typically have limited capability to recognize and segregate a data traffic based on an importance of data packets and to determine the importance of the data packets based on source and destination addresses. Also, as an amount of policy changes to identify and mark a priority of the data packets is very high, it makes it difficult for the edge routers to process such data packets. There is also a need for network engineers' intervention to change these policies manually. Furthermore, if the edge routers receive a data traffic greater than an available inter-DC bandwidth, the edge routers try to keep data packets of such data traffic in their buffer and eventually drop extra packets after the buffer is overwhelmed. These dropped data packets may belong to important applications which may adversely affect service level agreements (SLAs) of a higher priority data traffic or customer experience. To avoid such situations, traffic shaping should be enabled to improve latencies, guaranteeing performance in order of traffic priorities and service identity.

Application based traffic shaping is the most commonly used traffic shaping, however in various companies, thousands of applications may be hosted in multiple zones and millions of application flows may be enabled among these applications, therefore it is very difficult to shape a traffic of each and every data flow (application flow). Also, as millions of data packets move across the data centers every second, it is important to mark priority in such data packets accurately to further improve the inter-DC bandwidth utilization and to provide smooth experience to users. In order to deal with such problems in some of the currently known solutions, an application level segregation is achieved with the help of virtual local area networks (VLANs), where each VLAN represents a function or an application and is associated with a unique subnet. Further, in such solutions machines associated with a similar class of application have an IP address allocated from a subnet of a same VLAN. For instance, if in an example information technology (IT) and human resource (HR) are considered as two different functions/applications associated with VLAN 10 and VLAN 20 respectively, VLAN 10 and VLAN 20 will have a unique IP subnet as stated. Furthermore, machines that are associated with the IT applications will have an IP from the VLAN 10 pool and machines that are associated with the HR application will have an IP from VLAN 20 pool. Thereafter, policies are applied based on the VLAN subnets to manage an inter-DC traffic of the applications. Generally, subnets which cater business critical applications are treated with high priorities. Therefore, in these currently known solutions the VLAN subnets form the basis for classifying and assigning priorities on the inter-DC gateway machines. There are a number of limitations of such currently known solutions such as an overhead to manage network policies to define priority and min/max bandwidth among the VLAN subnets etc. Also, VLAN subnet management among a class of applications is a difficult task. For instance, if there is an exhaustion of IPs in a VLAN subnet for any class of applications, one needs to carve out new subnets and define policies again on newly carved out subnets. Furthermore, the currently known solutions encompasses use of IPTables to mark priorities of data packets which further has a number of limitations such as it requires a huge number of machines to process a few hundred GBPS of data and adds huge latency to process data packets packet which is not acceptable in production environments.

Therefore, there is a need in the art to provide a solution to effectively and efficiently shape an inter-datacenter traffic based on dynamically marking of a priority for one or more inter-datacenter data packets of said inter-datacenter traffic.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for dynamically shaping an inter-datacenter traffic. Also, an object of the present invention is to provide identity aware dynamic inter-dc traffic shaping using eBPF XDP techstack. Another object of the present invention is to enable traffic shaping to improve latencies, to guarantee performance in order of traffic priorities and service identity. Another object of the present invention is to provide a mechanism to manage an inter-datacenter bandwidth efficiently among applications to provide a smooth experience to users. Yet another an object of the present invention is to mark priority in data packets accurately to improve inter-DC bandwidth utilization and to provide smooth experience to users by enabling traffic shaping at edge routers. Yet another object of the present invention is to provide a minimum bandwidth for each priority to avoid starvation for data transmission.

Furthermore, in order to achieve the aforementioned objectives, the present invention provides a method and system for dynamically shaping an inter-datacenter traffic based on marking of a priority of each inter-datacenter data packet associated with the inter-datacenter traffic, using an eBPF XDP techstack.

A first aspect of the present invention relates to the method for dynamically shaping an inter-datacenter traffic. The method comprises receiving, at a gateway server, one or more inter-datacenter data packets of the inter-datacenter traffic, wherein each inter-datacenter data packet from the one or more inter-datacenter data packets is associated with at least one of a corresponding application and a corresponding application interaction. The method thereafter encompasses identifying, by the gateway server, one or more target application flow policies for said each inter-datacenter data packet from one or more application flow policies pre-stored in one or more eBPF maps for one or more inter-datacenter data packets associated with at least one of one or more applications and one or more application interactions. The method thereafter leads to dynamically marking, by the gateway server, a priority for said each inter-datacenter data packet using an eBPF XDP techstack, based at least on the identified one or more target application flow policies of said each inter-datacenter data packet. Further the method encompasses transmitting, from the gateway server to an edge router, said each inter-datacenter data packet with the corresponding marked priority. The method further comprises dynamically shaping, by the gateway server via the edge router, the inter-datacenter traffic based on said each inter-datacenter data packet and the corresponding marked priority of said each inter-datacenter data packet.

Another aspect of the present invention relates to a system/gateway server for dynamically shaping an inter-datacenter traffic. The gateway server comprises a transceiver unit, configured to receive, one or more inter-datacenter data packets of the inter-datacenter traffic, wherein each inter-datacenter data packet from the one or more inter-datacenter data packets is associated with at least one of a corresponding application and a corresponding application interaction. Further the gateway server comprises an identification unit, configured to identify, one or more target application flow policies for said each inter-datacenter data packet from one or more application flow policies pre-stored in one or more eBPF maps for one or more inter-datacenter data packets associated with at least one of one or more applications and one or more application interactions. The gateway server thereafter comprises a processing unit, configured to dynamically mark, a priority for said each inter-datacenter data packet using an eBPF XDP techstack, based at least on the identified one or more target application flow policies of said each inter-datacenter data packet. Further the transceiver unit is further configured to transmit to an edge router, said each inter-datacenter data packet with the corresponding marked priority. Also, the processing unit is further configured to dynamically shape via the edge router, the inter-datacenter traffic based on said each inter-datacenter data packet and the corresponding marked priority of said each inter-datacenter data packet.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary traditional Leaf and Spine network architecture, in accordance with exemplary embodiments of the present invention.

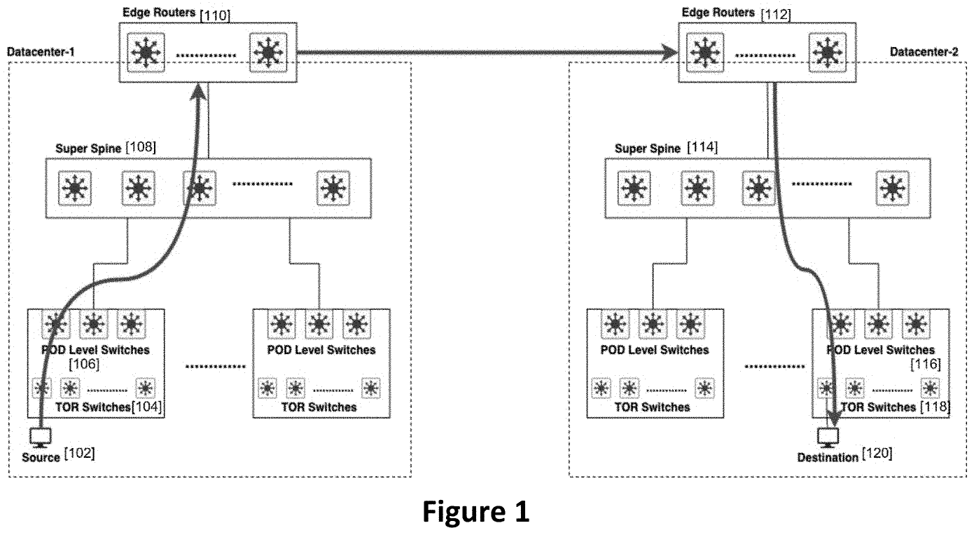

FIG. 2 illustrates an exemplary proposed Leaf and Spine network architecture, in accordance with exemplary embodiments of the present invention.

FIG. 3 illustrates an exemplary block diagram of a system/gateway server [300] for dynamically shaping an inter-datacenter traffic, in accordance with exemplary embodiments of the present invention.

FIG. 4 illustrates exemplary packet flows of an inter-datacenter traffic, for dynamically shaping the inter-datacenter traffic, in accordance with exemplary embodiments of the present invention.

FIG. 5 illustrates an exemplary method flow diagram [500], for dynamically shaping an inter-datacenter traffic, in accordance with exemplary embodiments of the present invention.

FIG. 6 depicts an experimental latency comparison between the IPTables and the eBPF XDP techstack based implementations.

FIG. 7 depicts an experimental bandwidth comparison between the IPTables and the eBPF XDP techstack based implementations.

FIG. 8 depicts an experimental CPU utilization comparison between the IPTables and the eBPF XDP techstack based implementations.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a transceiver unit, a processing unit, an identification unit, a storage unit and any other such unit(s) which are required to implement the features of the present disclosure.

As used herein, “application” can generate a data traffic, can receive a data traffic from another application(s)/user(s)/unit(s) and/or can transmit a data traffic to another application(s)/user(s)/unit(s), wherein such receiving and/or transmitting of data traffic indicates an application interaction.

As used herein, “datacenter” or “DC” is a physical facility containing a group of machines/computers that organizations use to house their critical applications and data.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

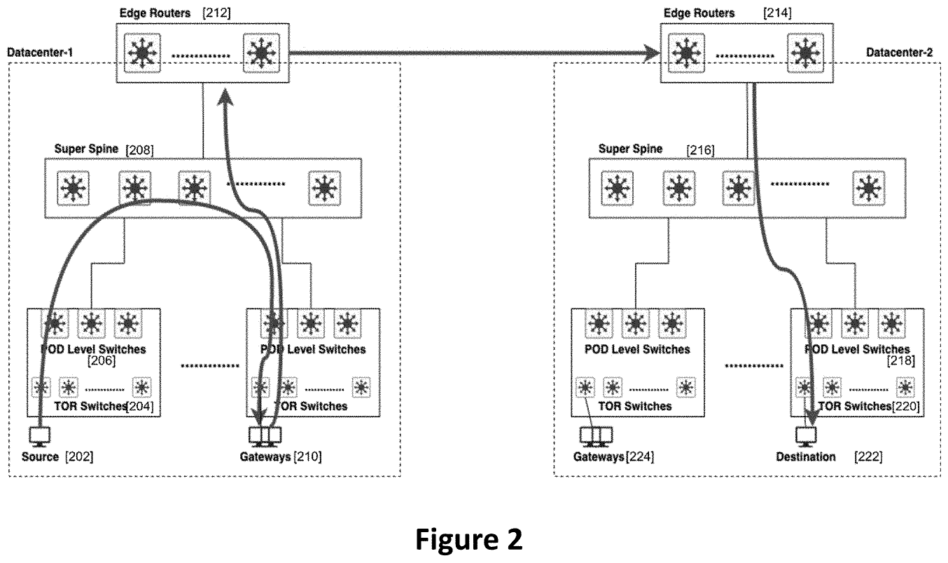

As disclosed in the background section the existing technologies have many limitations and in order to overcome at least some of the limitations of the prior known solutions, the present disclosure provides a solution to dynamically shape an inter-datacenter traffic associated with at least one of one or more applications and one or more application interactions based on marking of a priority for one or more inter-datacenter data packets of said inter-datacenter traffic. More particularly, the present invention in order to dynamically shape the inter-datacenter traffic routes said inter-datacenter traffic from a source server to a destination server via one or more gateway servers. Once the one or more inter-datacenter data packets of said inter-datacenter traffic received at the one or more gateway server, each gateway server assigns a priority to each inter-datacenter data packet received on it. Furthermore, said each gateway server from the one or more gateway server assigns the priority to the each inter-datacenter data packet received on it by marking a type of service (TOS) value in an IP header of said each inter-datacenter data packet, wherein said priority is assigned using an eBPF XDP techstack. In an implementation the marking of the type of service (TOS) value may further comprises marking of a Differentiated Services Code Point (DSCP) value in the IP header of said each inter-datacenter data packet. Also, the marking of the priority to the one or more inter-datacenter data packets by the one or more gateway servers is based on at least one of an application associated with said one or more inter-datacenter data packets, an application interaction associated with said one or more inter-datacenter data packets and a source, a destination, a protocol and a port details associated with said one or more inter-datacenter data packets. Furthermore, the eBPF XDP techstack in order to mark the priority to the one or more inter-datacenter data packets also uses one or more application flow policies, wherein the one or more application flow policies are pre-stored in one or more eBPF maps. Further, once the one or more inter-datacenter data packets are marked with corresponding priorities, said one or more inter-datacenter data packets are redirected to a destination server at least via one or more edge routers, wherein at the one or more edge routers the inter-datacenter traffic is dynamically shaped based on the TOS value of each inter-datacenter data packet received at said one or more edge routers. Furthermore, FIG. 2 illustrates an exemplary proposed Leaf and Spine network architecture, in accordance with exemplary embodiments of the present invention, where the routing/redirection of the one or more inter-datacenter data packets is indicated to implement the features of the present invention. FIG. 2 depicts that one or more inter-datacenter data packets are tunneled to a gateway server [210] in a source DC from a source [202], such that from the source [202] the one or more inter-datacenter data packets are firstly transmitted to one or more TOR switches [204]. The one or more TOR switches [204] thereafter transmits the one or more inter-datacenter data packets to one or more POD level switches [206], which further transmits the one or more inter-datacenter data packets to one or more super spines [208]. From the one or more super spines [208], the one or more inter-datacenter data packets are thereafter transmitted to the gateway server [210] via the one or more POD level switches [206] and the one or more TOR switches [204], respectively. A priority of the one or more inter-datacenter data packets is then marked on the gateway server [210] using the eBPF XDP techstack. Once the priority marking is completed the gateway server [210], the one or more inter-datacenter data packets are redirected to a destination server [222] in a destination DC via the one or more TOR switches [204], the one or more POD level switches [206], the one or more super spines [208] and one or more edge routers [212] respectively in the source DC and thereafter via one or more edge routers [214], one or more super spines [216], one or more POD level switches [218] and one or more TOR switches [220] respectively in the destination DC. Furthermore, at the one or more edge routers [212], the inter-datacenter traffic is dynamically shaped based on the making of the priority of the one or more inter-datacenter data packets. Also, in an implementation a response generated at the destination server [222] in the destination DC is also dynamically shaped at the one or more edge routers [214] based on a making of priority to one or more inter-datacenter data packets associated with said generated response at the gateway server [224], in accordance with the implementation of the features of the present invention.

Based on the implementation of the features of the present invention, a priority in inter-datacenter data packets is marked accurately and an inter-DC bandwidth utilization is improved and a smooth experience is provided to users by enabling traffic shaping at one or more edge routers. Also, the present invention provides a solution where each priority bucket (or a priority assigned to each type of inter-datacenter traffic) is given a minimum and maximum bandwidths to enable traffic shaping. More specifically, the maximum bandwidths are allocated in an order of priorities, such that an inter datacenter traffic with highest priority is first allocated with a maximum bandwidth from a bandwidth available after fulfilling a minimum bandwidth requirement of all priorities. Thereafter, an inter datacenter traffic with a second highest priority (i.e. the second highest priority in an order of highest to lowest priorities) will be allocated with a maximum bandwidth from a bandwidth available after fulfilling maximum bandwidth requirement of the inter datacenter traffic with highest priority. This process of allocation of maximum bandwidth continues in the order of highest to lowest priorities till an allocation of a maximum bandwidth to an inter datacenter traffic associated with a lowest priority or till no bandwidth is available for a lower priority inter datacenter traffic after fulfilling maximum bandwidth requirement of an inter datacenter traffic with a higher priority inter datacenter traffic. Therefore, minimum bandwidths are always guaranteed for each priority which helps to avoid starvation for data transmission. Similarly, maximum bandwidth that is allocated in the order or priorities for each priority helps to allocate the maximum bandwidths for each priority when a network has some additional bandwidth to use. Also, based on the implementation of the features of the present invention millions of inter-datacenter data packets can be marked dynamically per second using eBPF XDP techstack and without any requirement of huge footprint of machines to mark the inter-datacenter data packets at this scale. Therefore, the present invention provides a technical advancement over currently known solutions at least by marking per second a priority to millions of inter-datacenter data packets and with very small set of machines.

Hereinafter, exemplary embodiments of the present disclosure will be described in detail with reference to the accompanying drawings so that those skilled in the art can easily carry out the present disclosure.

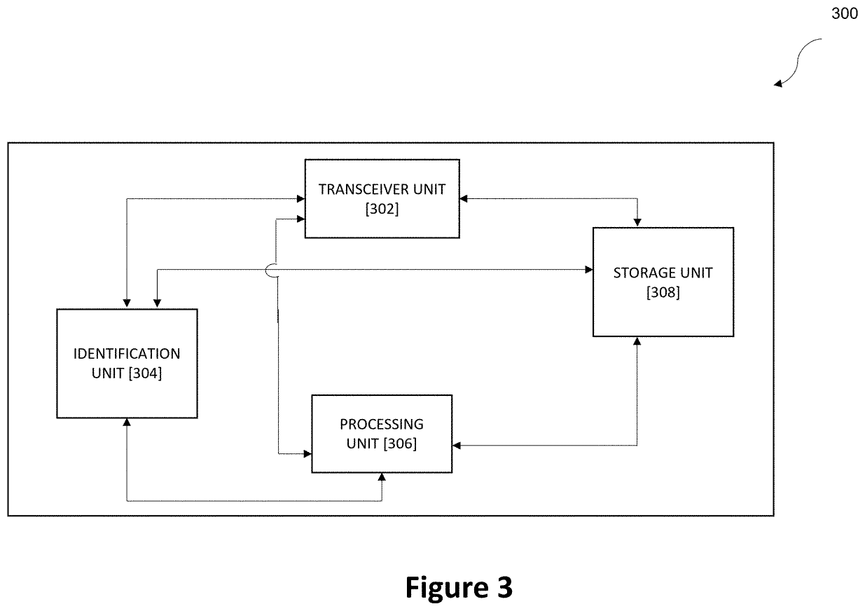

Referring to FIG. 3, an exemplary block diagram of a gateway server/system [300] for dynamically shaping an inter-datacenter traffic is shown. The gateway server [300] comprises at least one transceiver unit [302], at least one identification unit [304], at least one processing unit [306] and at least one storage unit [308]. Also, all of the components/units of the gateway server [300] are assumed to be connected to each other unless otherwise indicated below. Also, in FIG. 3 only a few units are shown, however, the gateway server [300] may comprise multiple such units or the gateway server [300] may comprise any such numbers of said units, as required to implement the features of the present disclosure. Further, in an implementation, the gateway server [300] is present in a datacenter to implement the features of the present invention.

The gateway server [300] is configured to dynamically shape an inter-datacenter traffic, with the help of the interconnection between the components/units of the gateway server [300].

In order to dynamically shape an inter-datacenter traffic of at least one of one or more applications and one or more application interactions, the transceiver unit [302] of the gateway server [300] is firstly configured to receive, one or more inter-datacenter data packets of said inter-datacenter traffic, wherein each inter-datacenter data packet from the one or more inter-datacenter data packets is associated with at least one of a corresponding application and a corresponding interaction. In an implementation the one or more inter-datacenter data packets of the inter-datacenter traffic may be received at the gateway server [300] via a network interface card (NIC) which is capable of implementing the features of the present invention. The inter-datacenter traffic is also associated with a particular category or type of traffic based on one or more associated application traffic patterns. In an implementation, in a typical web company the inter-datacenter traffic may be one of an Infrastructure traffic type, a Call Path Traffic type, a Call-Path Replication traffic type, a Non-Call-Path Replication traffic type and an Elephant/Bulk traffic type, but the traffic types of the inter-datacenter traffic are not limited to these traffic types and other traffic types may be defined based on various use cases. More particularly, in an event where an application traffic pattern of the inter-datacenter traffic comprises one or more infrastructure services traffic flows, the inter-datacenter traffic in such event is the infrastructure traffic type inter-datacenter traffic. Also, in an event where an application traffic pattern of the inter-datacenter traffic comprises an information exchanged across DC's by one or more user path services, the inter-datacenter traffic in such event is the Call Path Traffic type inter-datacenter traffic. The Call Path Traffic type inter-datacenter traffic is very critical and demands reliability to ensure guaranteed SLAs. Further in an event where one or more services running in an Active-Active or an Active-Passive mode need cross datacenter replication to maintain a unified state across regions for the call-path traffic, an associated inter-datacenter traffic in such event is the Call-Path Replication traffic type inter-datacenter traffic. The Call-Path Replication traffic type inter-datacenter traffic is mostly generated by a stored data. Also, in an event where one or more non-call-path services running in the Active-Active or the Active-Passive mode need cross datacenter replication to maintain a unified state across regions for a non-call-path traffic (i.e. a non-user path traffic), an associated inter-datacenter traffic in such event is the Non-Call-Path Replication traffic type inter-datacenter traffic. Further in an event where a large volume of data transfer requirements like archival, backups, etc. are there and any inter-datacenter traffic other than the Infrastructure traffic type, the Call Path Traffic type, the Call-Path Replication traffic type and/or the Non-Call-Path Replication traffic type etc. is there, the inter-datacenter traffic in such event is categorized as elephant/Bulk traffic type inter-datacenter traffic. The Bulk traffic type inter-datacenter traffic is required to be regulated so that it does not overwhelm the other traffic types. Furthermore, the types of the inter-datacenter traffic are not limited and there can be other categories/types of the inter-datacenter traffic based on one or more associated application traffic patterns and/or use case(s).

Once the one or more inter-datacenter data packets of the inter-datacenter traffic are received at the transceiver unit [302], the transceiver unit [302] transmits the received one or more inter-datacenter data packets to the identification unit [304]. The identification unit [304] is thereafter configured to identify, one or more target application flow policies for each inter-datacenter data packet from the one or more inter-datacenter data packets of the inter-datacenter traffic, wherein the one or more target application flow policies for said each inter-datacenter data packet are identified from one or more application flow policies pre-stored in one or more eBPF maps for one or more inter-datacenter data packets associated with at least one of the one or more applications and one or more application interactions. The one or more application flow policies pre-stored in the one or more eBPF maps are one or more user defined application flow policies and are associated with one or more application flow priorities of at least one of the one or more applications and the one or more application interactions. The one or more application flow priorities of at least one of the one or more applications and the one or more application interactions indicates one or more priorities corresponding to one or more flows of an application traffic of the one or more applications and/or one or more application interactions. In an implementation, ‘n’ application flow policies may be pre-stored in eBPF maps for a plurality of inter-datacenter data packets associated with one or more applications and/or one or more application interactions, wherein such ‘n’ application flow policies are associated with one or more application flow priorities (i.e. one or more priorities corresponding to one or more flows of an application traffic) of the one or more applications and/or the one or more application interactions. More particularly, each policy from the ‘n’ application flow policies comprises an application flow priority for one or more inter-datacenter data packets of the one or more applications and/or the application interactions. The one or more application flow priorities of the one or more applications and/or the one or more application interactions are defined based on a grouping of a plurality of network elements associated with the one or more applications and/or the one or more application interactions. The grouping of the plurality of network elements may be a grouping of at least one of a plurality of instances and a plurality of load-balancer virtual IPs associated with the one or more applications and/or the one or more application interactions, wherein the grouping of the plurality of network elements is done within a zone and/or across zones (DCs) as the one or more applications and/or the one or more application interactions operates in the multi-zone (multi-datacenter) mode. Also, the grouping of the plurality of network elements based on a user input. More particularly, once the grouping of the plurality of network elements is defined based on the user input, the one or more application flow policies comprising of the one or more application flow priorities of the one or more applications and/or the one or more application interactions are defined, wherein the one or more application flow priorities are defined based on one or more groups of the plurality of network elements associated with said one or more applications and/or the one or more application interactions. Furthermore, the one or more groups of the plurality of network elements are defined to define traffic prioritization policies (i.e. the one or more application flow policies) more efficiently as there are huge data flows of the one or more applications across the data centers. For instance, in an example if there are 20 thousands Hypervisors and around 50 thousands virtual instances of a plurality of applications across two data centers, defining one or more application flow policies among these instances at an instance IP level is not feasible and scalable. Therefore in the given instance one or more groups of plurality of network elements associated with the plurality of applications are defined across the two zones (DCs) to define the one or more application flow policies among said 20 thousands Hypervisors and around 50 thousands virtual instances. Furthermore, an inter-datacenter traffic going out of a group of a plurality of network elements towards another group of a plurality of network elements carries a same priority. Also in an implementation one or more instances and/or one or more virtual IPs may be attached or detached from the one or more groups of the plurality of network elements based on the user input.

Furthermore, in an implementation the processing unit [306] is also configured to define the one or more application flow priorities of the one or more applications and/or the one or more application interactions based on one or more application traffic patterns (or traffic types). More particularly, in typical web companies the one or more application flow priorities of the one or more applications and/or the one or more application interactions associated with the one or more application flow policies may be defined based on at least one of the Infrastructure traffic type, the Call Path Traffic type, the Call-Path Replication traffic type, the Non-Call-Path Replication traffic type, the Elephant/Bulk traffic type and the like traffic type(s). The one or more application flow priorities of the one or more applications and/or the one or more application interactions are defined based on the one or more application traffic patterns/traffic types as there may be millions of application flows (i.e. millions of flows of an application traffic of the one or more applications) between the data centers and it is very hard to shape priorities for each application flow manually. Furthermore, in an example, depending on a use case the one or more application flow priorities defined based on the Infrastructure traffic type are one or more highest-priority application flow priorities followed by the one or more application flow priorities defined based on the Call Path Traffic type, the Call-Path Replication traffic type, the Non-Call-Path Replication traffic type and the Elephant/Bulk traffic type, respectively. Therefore, in the given example, the one or more application flow priorities defined based on the Elephant/Bulk traffic type are one or more least-priority application flow priorities. In an implementation the processing unit [306] is also configured to update in real time the one or more application flow policies pre-stored in the one or more eBPF maps based on at least one of a source network group detail, a destination network group detail, a destination port detail, a protocol detail and a priority detail associated with the one or more inter-datacenter data packets associated with the one or more applications and the one or more application interactions, wherein the network group indicates a group of network elements. Also, in such implementation the source network group detail, the destination network group detail, the destination port detail, the protocol detail and the priority detail associated with the one or more inter-datacenter data packets of the one or more applications and/or the one or more application interactions are received at the processing unit [306] as a user input to update in real time the one or more application flow policies pre-stored in the one or more eBPF maps. The one or more application flow policies may be updated at any instant of time or in real time based on a use case or a user requirement. Further in the given implementation the processing unit [306] is also configured to update in real time, the one or more eBPF maps based on the updated one or more application flow policies pre-stored in the one or more eBPF maps. The processing unit [306] is configured to update the one or more eBPF maps in order to further enable identification one or more target application flow policies for the one or more inter-datacenter data packets at least from the updated one or more eBPF maps, wherein said one or more target application flow policies are identified based on one or more fields present in headers of the one or more inter-datacenter data packets. Also, the one or more target application flow policies are further used to assign a priority to the one or more inter-datacenter data packets.

Further, once the one or more target application flow policies for each inter-datacenter data packet from the one or more inter-datacenter data packets of the inter-datacenter traffic are identified from the one or more application flow policies pre-stored in the one or more eBPF maps/one or more updated eBPF maps, the identification unit [304] is configured to provide the identified one or more target application flow policies for said each inter-datacenter data packet to the processing unit [306]. Further the processing unit [306] is configured to dynamically mark, a priority for said each inter-datacenter data packet using an eBPF (extended Berkeley Packet Filter) XDP (eXpress Data Path) techstack, based at least on the identified one or more target application flow policies of said each inter-datacenter data packet. In an implementation, if more than one target application flow policies of said each inter-datacenter data packet are identified, in such implementation based on a use case, the processing unit [306] is configured to select a target application flow policy with highest priority to dynamically mark the priority for said each inter-datacenter data packet associated with more than one target application flow policies. In another implementation, if more than one target application flow policies of said each inter-datacenter data packet are identified, in such implementation based on a use case, the processing unit [306] is configured to select a target application flow policy with lowest priority to dynamically mark the priority for said each inter-datacenter data packet associated with more than one target application flow policies. Therefore, in events where more than one target application flow policies of each inter-datacenter data packet are identified, a target application flow policy may be selected by the processing unit [306] to mark the priority based on a use case. The eBPF is a construct in linux kernel allowing to execute bytecode at various hook points, making the linux kernel programmable. The eBPF enables adding additional protocol parsers and easily program any forwarding logic without ever leaving a packet processing context of the linux kernel. The XDP is a new Linux kernel component that highly improves packet processing performance, makes it more constant and predictable. With kernel bypass plus a combination of other features (batch packet processing) and performance tuning adjustments (NUMA awareness, CPU isolation, etc.), the XDP confirms a basis of high-performance user-space networking. The processing unit [306] in order to dynamically mark, the priority for said each inter-datacenter data packet encompasses use of the eBPF XDP techstack to lookup the one or more target application flow policies of said each inter-datacenter data packet to further identify the priority for said each inter-datacenter data packet using at least one of a source IP address, a destination IP address, a source port, a destination port and a protocol associated with the each inter-datacenter data packet. For instance, in an implementation the processing unit [306] in order to dynamically mark, a priority for an inter-datacenter data packet associated with an application encompasses use of the eBPF XDP techstack to lookup the one or more target application flow policies of said inter-datacenter data packet to further identify the priority for said each inter-datacenter data packet using a source IP address, a destination IP address, a destination port and a protocol associated with the inter-datacenter data packet. Also, in one other implementation the processing unit [306] in order to dynamically mark, a priority for an inter-datacenter data packet associated with an application interaction encompasses use of the eBPF XDP techstack to lookup the one or more target application flow policies of said inter-datacenter data packet to further identify the priority for said each inter-datacenter data packet using a source IP address, a destination IP address, a source port, a destination port and a protocol associated with the inter-datacenter data packet. Therefore, the dynamically marking of the priority for said each inter-datacenter data packet is also based on the source details, the destination details and the protocol details associated with said each inter-datacenter data packet. More particularly, in order to dynamically mark the priority for said each inter-datacenter data packet, the processing unit [306] is configured to mark a type of service (TOS) value in an IP header of said each inter-datacenter data packet using the eBPF XDP techstack and the one or more target application flow policies of said each inter-datacenter data packet. In an implementation the marking of the type of service (TOS) value may further comprises marking of a Differentiated Services Code Point (DSCP) value in the IP header of said each inter-datacenter data packet. Furthermore, in an implementation the dynamically marking of the priority for said each inter-datacenter data packet may be based on a type of inter-datacenter traffic associated with said each inter-datacenter data packet. For instance, if the type of inter-datacenter traffic associated with said each inter-datacenter data packet is the Infrastructure traffic type, in such instance the processing unit [306] is configured to mark ‘IAAS’ for the priority for said each inter-datacenter data packet. If the type of inter-datacenter traffic associated with said each inter-datacenter data packet is the Call Path Traffic type, in such instance the processing unit [306] is configured to mark ‘CALL_PATH’ for the priority for said each inter-datacenter data packet. Further if the type of inter-datacenter traffic associated with said each inter-datacenter data packet is the Call-Path Replication traffic type, in such instance the processing unit [306] is configured to mark ‘CALLPATH_REPLICATION’ for the priority for said each inter-datacenter data packet. Also, if the type of inter-datacenter traffic associated with said each inter-datacenter data packet is the Non-Call-Path Replication traffic type, in such instance the processing unit [306] is configured to mark ‘NON-CALLPATH REPLICATION’ for the priority for said each inter-datacenter data packet. Further, if the type of inter-datacenter traffic associated with said each inter-datacenter data packet is the Bulk traffic type, in such instance the processing unit [306] is configured to mark ‘BULK’ for the priority for said each inter-datacenter data packet. In an example, depending on a use case, the priority marked as ‘IAAS’ indicates a first priority (i.e. highest priority), the priority marked as ‘CALL_PATH’ indicates a second priority (i.e. second highest priority), the priority marked as ‘CALLPATH_REPLICATION’ indicates a third priority (i.e. third highest priority), the priority marked as ‘NON-CALLPATH REPLICATION’ indicates a fourth priority (i.e. fourth highest priority) and the priority marked as ‘BULK’ indicates a fifth priority (i.e. fifth/least highest priority), wherein such marking of priority based on the type of inter-datacenter traffic associated with said each inter-datacenter data packet is in accordance with one or more application flow priorities associated with the one or more target application flow policies of said each inter-datacenter data packet. Furthermore, in an implementation if no application flow policies for one or more inter-datacenter data packets are defined, in such implementation ‘DEFAULT’ may be marked to indicate a default priority for a type of inter-datacenter traffic associated with said one or more inter-datacenter data packets, wherein ‘DEFAULT’ may be any priority type such as including but not limited to ‘CALLPATH_REPLICATION’, ‘CALL_PATH’, ‘IAAS’ etc.

Once the priority for said each inter-datacenter data packet is dynamically marked using the eBPF XDP techstack, the processing unit [306] is thereafter configured to provide said each inter-datacenter data packet with the corresponding dynamically marked priority to the transceiver unit [302]. Thereafter, the transceiver unit [302] is configured to transmit to an edge router, said each inter-datacenter data packet with the corresponding dynamically marked priority. Once said each inter-datacenter data packet with the corresponding dynamically marked priority is received at the edge router, the processing unit [306] is configured to dynamically shape via the edge router, the inter-datacenter traffic based on said each inter-datacenter data packet and the corresponding dynamically marked priority received at the edge router. More specifically, processing unit [306] is configured to dynamically shape via the edge router, the inter-datacenter traffic based on the TOS value marked in the IP header of said each inter-datacenter data packet received at the edge router. The processing unit [306] enables the edge router to dynamically shape, an inter-datacenter traffic received at the edge router by reading the TOS value marked in the IP header of each inter-datacenter data packet of said inter-datacenter traffic received at the edge router. Furthermore, the processing unit [306] is also configured to enable the edge router to assign a minimum bandwidth and a maximum bandwidth to a marked priority. More particularly, the processing unit [306] is configured to enable the edge router to assign to: a priority assigned to each type of inter-datacenter traffic (for instance ‘CALL_PATH’, ‘IAAS’ etc.), a respective minimum bandwidth and a respective maximum bandwidth in order to enable traffic shaping. More specifically, the maximum bandwidths are allocated in an order of priorities, such that an inter datacenter traffic with highest priority is first allocated with a maximum bandwidth from a bandwidth available after fulfilling a minimum bandwidth requirement of all priorities. Thereafter, an inter datacenter traffic with a second highest priority (i.e. the second highest priority in an order of highest to lowest priorities) will be allocated with a maximum bandwidth from a bandwidth available after fulfilling maximum bandwidth requirement of the inter datacenter traffic with highest priority. This process of allocation of maximum bandwidth continues in the order of highest to lowest priorities till an allocation of a maximum bandwidth to an inter datacenter traffic associated with a lowest priority or till no bandwidth is available for a lower priority inter datacenter traffic after fulfilling maximum bandwidth requirement of an inter datacenter traffic with a higher priority inter datacenter traffic. Therefore, minimum bandwidths are always guaranteed for each marked priority (i.e. for ‘CALL_PATH’, ‘IAAS’ etc. priorities) which helps to avoid starvation for data transmission. Similarly, maximum bandwidth that is allocated in the order or priorities for each marked priority (i.e. for ‘CALL_PATH’, ‘IAAS’ etc. priorities) helps to allocate the maximum bandwidths for said each marked priority when a network has some additional bandwidth to use.

In an implementation in each datacenter, a cluster of gateway servers [300] may be configured to mark one or more data packets using the eBPF/XDP techstack. These gateway servers [300] may be split into two groups and placed in two different pods to reduce a probability of hot spotting. Also, the gateway servers [300] are added in a data path and if there is an outage of the gateway servers [300], traffic is moved to edge routers directly. There won't be any traffic shaping enabled during the gateway servers outage. All data packets are considered with default priority during that period. Furthermore, the features of the present disclosure are not limited to dynamically shaping of an inter-datacenter traffic from a source in one datacenter to a destination in another datacenter, however in an implementation a response provided to such inter-datacenter traffic may be also be prioritized using the features of the present invention. In such cases the initial source will act as a new destination and the former destination will act as a new source.

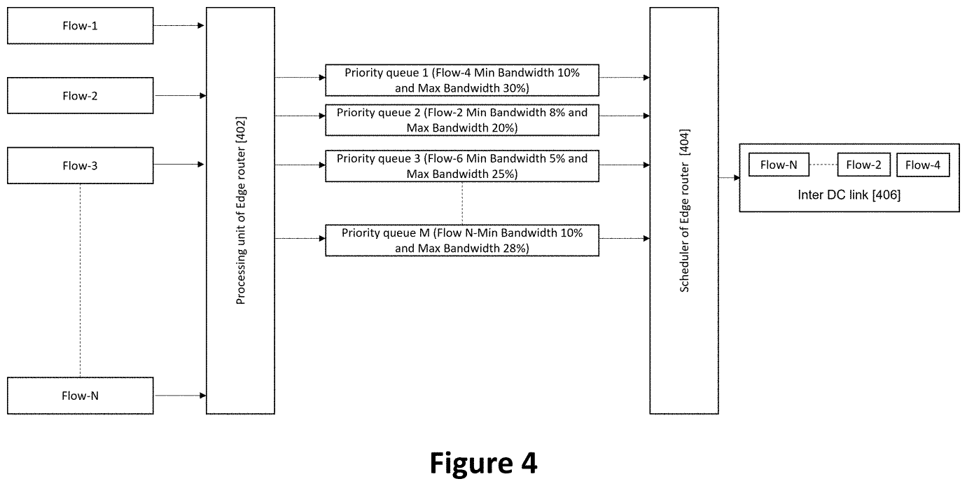

Further, FIG. 4 illustrates exemplary packet flows of an inter-datacenter traffic, for dynamically shaping the inter-datacenter traffic, in accordance with exemplary embodiments of the present invention. More specifically, FIG. 4 depicts a plurality of packet flows of the inter-datacenter traffic (i.e. Flow-1, Flow-2, . . . Flow-N), wherein each of the packet flow from the plurality of packet flows of the inter-datacenter traffic is assigned with a priority based on the implementation of the features of the present invention. Further, FIG. 4 depicts a processing unit of an edge router at [402] and a scheduler unit of the edge router at [404]. The plurality of packet flows of the inter-datacenter traffic (i.e. Flow-1, Flow-2 . . . Flow-N) are received at the processing unit [402] of the edge router via a transceiver unit, wherein the plurality of packet flows of the inter-datacenter traffic are received along with corresponding priorities that assigned based on at least one of DSCP and TOS values. The processing unit [402] thereafter based on the corresponding priorities of the received plurality of packet flows assigns at least one of the minimum bandwidth and the maximum bandwidth to said corresponding priorities. Thereafter the edge router via the processing unit [402] categorizes each of the packet flow from the plurality of packet flows into ‘M’ priority queues (or priority buckets) such that each priority queue is given a min bandwidth and a max bandwidth to enable traffic shaping. For instance, FIG. 4 depicts categorized priority queues such as Flow-4 is categorized in a priority queue 1 which is assigned to Min Bandwidth 10% and Max Bandwidth 30%, Flow-2 is categorized in a priority queue 2 which is assigned to Min Bandwidth 8% and Max Bandwidth 20% etc.

Thereafter, the scheduler [404] is configured to transmit the plurality of packet flows of the inter-datacenter traffic on an inter DC link [406], wherein the plurality of packet flows are transmitted on the inter DC link based on the corresponding priorities and the corresponding priority queues. For instance, FIG. 4 depicts an exemplary scenario where at [406] the Flow-4 is transmitted first followed by the Flow-2, Flow-6 . . . Flow-N based on their corresponding priority and respective categorized priority queue.

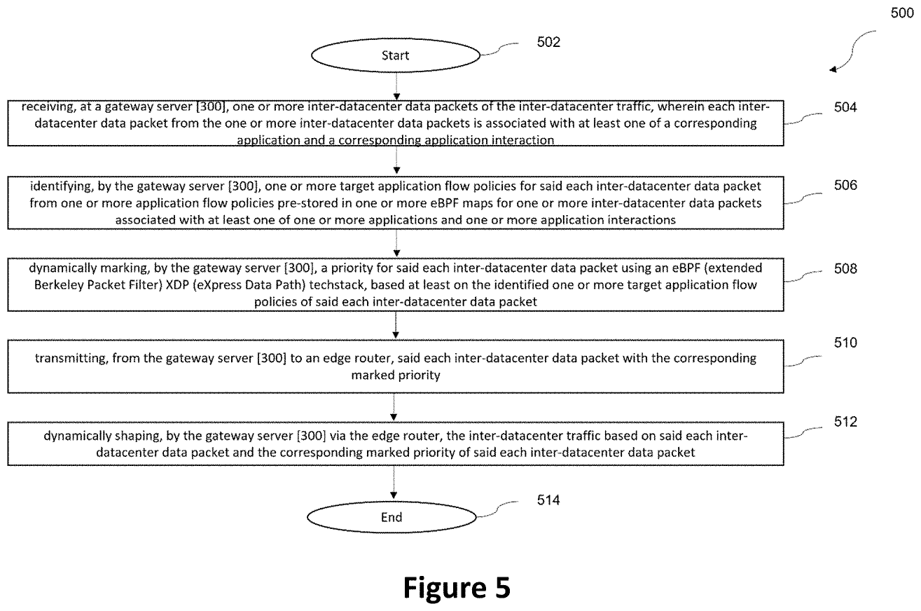

Referring to FIG. 5 an exemplary method flow diagram [500], for dynamically shaping an inter-datacenter traffic, in accordance with exemplary embodiments of the present invention is shown. In an implementation the method is performed by the gateway server [300]. Further, in an implementation, the gateway server [300] may be present in a datacenter to implement the features of the present invention. Also, as shown in FIG. 5, the method starts at step [502].

Further in order to dynamically shape an inter-datacenter traffic of at least one of one or more applications and one or more application interactions, at step [504] the method comprises receiving, at a gateway server [300], one or more inter-datacenter data packets of the inter-datacenter traffic, wherein each inter-datacenter data packet from the one or more inter-datacenter data packets is associated with at least one of a corresponding application and a corresponding application interaction. In an implementation the one or more inter-datacenter data packets of the inter-datacenter traffic may be received at the gateway server [300] via a network interface card (NIC) which is capable of implementing the features of the present invention. The inter-datacenter traffic is also associated with a particular category or type of traffic based on one or more associated application traffic patterns. In an implementation, in a typical web company, the inter-datacenter traffic may be one of an Infrastructure traffic type, a Call Path Traffic type, a Call-Path Replication traffic type, a Non-Call-Path Replication traffic type and an Elephant/Bulk traffic type, but the traffic types of the inter-datacenter traffic are not limited to these traffic types and other traffic types may be defined based on various use cases. More particularly, in an event where an application traffic pattern of the inter-datacenter traffic comprises one or more infrastructure services traffic flows, the inter-datacenter traffic in such event is the infrastructure traffic type inter-datacenter traffic. Further, in an event where an application traffic pattern of the inter-datacenter traffic comprises an information exchanged across DC's by one or more user path services/applications, the inter-datacenter traffic in such event is the Call Path Traffic type inter-datacenter traffic. The Call Path Traffic type inter-datacenter traffic is very critical and demands reliability to ensure guaranteed SLAs. Also, in an event where one or more services running in an Active-Active or an Active-Passive mode need cross datacenter replication to maintain a unified state across regions for the call-path traffic, an associated inter-datacenter traffic in such event is the Call-Path Replication traffic type inter-datacenter traffic. The Call-Path Replication traffic type inter-datacenter traffic is mostly generated by a stored data. Also, in an event where one or more non-call-path services running in the Active-Active or the Active-Passive mode need cross datacenter replication to maintain a unified state across regions for a non-call-path traffic (i.e. a non-user path traffic), an associated inter-datacenter traffic in such event is the Non-Call-Path Replication traffic type inter-datacenter traffic. Further in an event where a large volume of data transfer requirements like archival, backups, etc. are there and any inter-datacenter traffic other than the Infrastructure traffic type, the Call Path Traffic type, the Call-Path Replication traffic type and/or the Non-Call-Path Replication traffic type etc. is there, the inter-datacenter traffic in such event is categorized as elephant/Bulk traffic type inter-datacenter traffic. The Bulk traffic type inter-datacenter traffic is required to be regulated so that it does not overwhelm the other traffic types. Furthermore, the types of the inter-datacenter traffic are not limited, and there can be other categories/types of the inter-datacenter traffic based on one or more associated application traffic patterns and/or various use cases.

Once the one or more inter-datacenter data packets of the inter-datacenter traffic are received at the gateway server [300], at step [506] the method comprises identifying, by the gateway server [300], one or more target application flow policies for said each inter-datacenter data packet from one or more application flow policies pre-stored in one or more eBPF maps for one or more inter-datacenter data packets associated with the one or more applications and/or the one or more application interactions. The one or more application flow policies pre-stored in the one or more eBPF maps are one or more user defined application flow policies and are associated with one or more application flow priorities of the one or more applications and/or the one or more application interactions. The one or more application flow priorities of the one or more applications and/or the one or more application interactions indicates one or more priorities corresponding to one or more flows of an application traffic of the one or more applications and/or the one or more application interactions. In an implementation, ‘n’ application flow policies may be pre-stored in eBPF maps for a plurality of inter-datacenter data packets associated with one or more applications and/or the one or more application interactions, wherein such ‘n’ application flow policies are associated with one or more application flow priorities (i.e. one or more priorities corresponding to one or more flows of an application traffic) of the one or more applications and/or the one or more application interactions. More particularly, each policy from the ‘n’ application flow policies comprises an application flow priority for transmission of one or more inter-datacenter data packets of the one or more applications and/or the one or more application interactions. The method also encompasses defining, the one or more application flow priorities of the one or more applications and/or the one or more application interactions based on a grouping of a plurality of network elements associated with the one or more applications and/or the one or more application interactions. The grouping of the plurality of network elements may be a grouping of at least one of a plurality of instances and a plurality of load-balancer virtual IPs associated with the one or more applications and/or the one or more application interactions, wherein the grouping of the plurality of network elements may be done within a zone and/or across zones (DCs) as the one or more applications and/or the one or more application interactions operates in the multi-zone (multi-datacenter) mode. Also, the method encompasses defining the grouping of the plurality of network elements based on a user input. More particularly, once the grouping of the plurality of network elements is defined based on the user input, the one or more application flow policies comprising of the one or more application flow priorities of the one or more application and/or the one or more application interactions are defined, wherein the one or more application flow priorities are defined based on one or more groups of the plurality of network elements associated with said one or more applications and/or the one or more application interactions. Furthermore, the one or more groups of the plurality of network elements are defined to define the one or more application flow policies more efficiently as there are huge data flows of the one or more applications across the data centers. For instance, in an example if there are 50 thousands Hypervisors and around 70 thousands virtual instances of a plurality of applications across two data centers, defining one or more application flow policies among these instances at an instance IP level is not feasible and scalable. Therefore in the given instance one or more groups of plurality of network elements associated with the plurality of applications are defined across the two zones (DCs) to define the one or more application flow policies among said 50 thousands Hypervisors and around 70 thousands virtual instances. Furthermore, an inter-datacenter traffic going out of a group of a plurality of network elements towards another group of a plurality of network elements carries a same priority. Also in an implementation one or more instances and/or one or more virtual IPs may be attached or detached from the one or more groups of the plurality of network elements based on the user input.

Furthermore, in an implementation the method also encompasses defining via the gateway server [300] the one or more application flow priorities of the one or more applications and/or the one or more application interactions based on one or more application traffic patterns (or traffic types). More particularly, in typical web companies, the one or more application flow priorities of the one or more applications and/or the one or more application interactions associated with the one or more application flow policies may be defined based on at least one of the Infrastructure traffic type, the Call Path Traffic type, the Call-Path Replication traffic type, the Non-Call-Path Replication traffic type, the Elephant/Bulk traffic type and the like traffic type. The one or more application flow priorities of the one or more applications and/or the one or more application interactions are defined based on the one or more application traffic patterns/traffic types as there may be millions of application flows between the data centers and it is very hard to shape priorities for each application flow manually. Furthermore, in an example, depending on a use case the one or more application flow priorities defined based on the Infrastructure traffic type are one or more highest-priority application flow priorities followed by the one or more application flow priorities defined based on the Call Path Traffic type, the Call-Path Replication traffic type, the Non-Call-Path Replication traffic type and the Elephant/Bulk traffic type, respectively. Therefore, in the given example, the one or more application flow priorities defined based on the Elephant/Bulk traffic type are one or more least-priority application flow priorities. In an implementation the method further comprises updating in real time by the gateway server [300] the one or more application flow policies pre-stored in the one or more eBPF maps based on at least one of a source network group detail, a destination network group detail, a destination port detail, a protocol detail and a priority detail associated with the one or more inter-datacenter data packets associated with the one or more applications and/or the one or more application interactions, wherein the network group indicates a group of network elements. Also, in such implementation the source network group detail, the destination network group detail, the destination port detail, the protocol detail and the priority detail associated with the one or more inter-datacenter data packets of the one or more applications and/or the one or more application interactions are received at the gateway server [300] as a user input to update in real time the one or more application flow policies pre-stored in the one or more eBPF maps. The one or more application flow policies may be updated at any instant of time or in real time based on a use case or a user requirement. Further in the given implementation the method also comprises updating in real time by the gateway server [300] the one or more eBPF maps based on the updated one or more application flow policies pre-stored in the one or more eBPF maps. The method encompasses updating by the processing unit [306], the one or more eBPF maps in order to further identify in real time one or more target application flow policies for the one or more inter-datacenter data packets at least from the updated one or more eBPF maps, wherein said one or more target application flow policies are identified based on one or more fields present in headers of the one or more inter-datacenter data packets. Also, the one or more target application flow policies are further used to assign a priority to the one or more inter-datacenter data packets.

Further, once the one or more target application flow policies for each inter-datacenter data packet from the one or more inter-datacenter data packets of the inter-datacenter traffic are identified from the one or more application flow policies pre-stored in the one or more eBPF maps/one or more updated eBPF maps, at step [508] the method comprises dynamically marking, by the gateway server [300], a priority for said each inter-datacenter data packet using an eBPF (extended Berkeley Packet Filter) XDP (eXpress Data Path) techstack, based at least on the identified one or more target application flow policies of said each inter-datacenter data packet. In an implementation, if more than one target application flow policies of said each inter-datacenter data packet are identified, in such implementation based on a use case, the method encompasses selecting by the processing unit [306], a target application flow policy with highest priority to dynamically mark the priority for said each inter-datacenter data packet associated with more than one target application flow policies. In another implementation, if more than one target application flow policies of said each inter-datacenter data packet are identified, in such implementation based on a use case, the method encompasses selecting by the processing unit [306], a target application flow policy with lowest priority to dynamically mark the priority for said each inter-datacenter data packet associated with more than one target application flow policies. Therefore, in events where more than one target application flow policies of each inter-datacenter data packet are identified, a target application flow policy may be selected by the processing unit [306] to mark the priority based on a use case. In order to dynamically mark, the priority for said each inter-datacenter data packet the method encompasses using by the gateway server [300], the eBPF XDP techstack to lookup the one or more target application flow policies of said each inter-datacenter data packet to further identify the priority for said each inter-datacenter data packet using at least one of a source IP address, a destination IP address, a source port, a destination port and a protocol associated with the each inter-datacenter data packet. For instance, in an implementation the gateway server [300] in order to dynamically mark, a priority for an inter-datacenter data packet associated with an application encompasses use of the eBPF XDP techstack to lookup the one or more target application flow policies of said inter-datacenter data packet to further identify the priority for said each inter-datacenter data packet using a source IP address, a destination IP address, a destination port and a protocol associated with the inter-datacenter data packet. Also, in one other implementation the gateway server [300] in order to dynamically mark, a priority for an inter-datacenter data packet associated with an application interaction encompasses use of the eBPF XDP techstack to lookup the one or more target application flow policies of said inter-datacenter data packet to further identify the priority for said each inter-datacenter data packet using a source IP address, a destination IP address, a source port, a destination port and a protocol associated with the inter-datacenter data packet. Therefore, the process of dynamically marking of the priority for said each inter-datacenter data packet by the gateway server [300] using the eBPF XDP techstack is also based on at least one of the source detail, the destination detail and the protocol detail associated with said each inter-datacenter data packet. More particularly, the process of dynamically marking of the priority for said each inter-datacenter data packet by the gateway server [300] using the eBPF XDP techstack comprises marking a type of service (TOS) value in an IP header of said each inter-datacenter data packet based on the one or more target application flow policies of said each inter-datacenter data packet. In an implementation the marking of the type of service (TOS) value may further comprises marking of a Differentiated Services Code Point (DSCP) value in the IP header of said each inter-datacenter data packet. Also, in an implementation the process of dynamically marking of the priority for said each inter-datacenter data packet by the gateway server [300] using the eBPF XDP techstack may be further based on a type of inter-datacenter traffic associated with said each inter-datacenter data packet. For instance, if the type of inter-datacenter traffic associated with said each inter-datacenter data packet is the Infrastructure traffic type, in such instance the method encompasses marking by the gateway server [300] ‘IAAS’ for the priority for said each inter-datacenter data packet. If the type of inter-datacenter traffic associated with said each inter-datacenter data packet is the Call Path Traffic type, in such instance the method encompasses marking by the gateway server [300] ‘CALL_PATH’ for the priority for said each inter-datacenter data packet. Further if the type of inter-datacenter traffic associated with said each inter-datacenter data packet is the Call-Path Replication traffic type, in such instance the method encompasses marking by the gateway server [300] ‘CALLPATH_REPLICATION’ for the priority for said each inter-datacenter data packet. Also, if the type of inter-datacenter traffic associated with said each inter-datacenter data packet is the Non-Call-Path Replication traffic type, in such instance the method encompasses marking by the gateway server [300] ‘NON-CALLPATH REPLICATION’ for the priority for said each inter-datacenter data packet. Further, if the type of inter-datacenter traffic associated with said each inter-datacenter data packet is the Bulk traffic type, in such instance the method encompasses marking by the gateway server [300] ‘BULK’ for the priority for said each inter-datacenter data packet. In an example, depending on a use case, the priority marked as ‘IAAS’ indicates a first priority (i.e. highest priority), the priority marked as ‘CALL_PATH’ indicates a second priority (i.e. second highest priority), the priority marked as ‘CALLPATH_REPLICATION’ indicates a third priority (i.e. third highest priority), the priority marked as ‘NON-CALLPATH REPLICATION’ indicates a fourth priority (i.e. fourth highest priority) and the priority marked as ‘BULK’ indicates a fifth priority (i.e. fifth/least highest priority), wherein such marking of priority based on the type of inter-datacenter traffic associated with said each inter-datacenter is in accordance with one or more application flow priorities associated with the one or more target application flow policies of said each inter-datacenter data packet. Furthermore, in an implementation if no application flow policies for one or more inter-datacenter data packets are defined, in such implementation ‘DEFAULT’ may be marked to indicate a default priority for a type of inter-datacenter traffic associated with said one or more inter-datacenter data packets, wherein ‘DEFAULT’ may be any priority type such as including but not limited to ‘CALLPATH_REPLICATION’, ‘CALL_PATH’, ‘IAAS’ etc.

Once the priority for said each inter-datacenter data packet is dynamically marked using the eBPF XDP techstack, at step [510] the method comprises transmitting, from the gateway server [300] to an edge router, said each inter-datacenter data packet with the corresponding marked priority. Once said each inter-datacenter data packet with the corresponding dynamically marked priority is received at the edge router, at step [512] the method comprises dynamically shaping, by the gateway server [300] via the edge router, the inter-datacenter traffic based on said each inter-datacenter data packet and the corresponding marked priority of said each inter-datacenter data packet received at the edge router. Further, the process of dynamically shaping of the inter-datacenter traffic by the gateway server [300] via the edge router is further based on the TOS value marked in the IP header of said each inter-datacenter data packet received at the edge router. The method encompasses enabling the edge router by the gateway server [300] to dynamically shape, an inter-datacenter traffic received at the edge router by reading the TOS value marked in the IP header of each inter-datacenter data packet of said inter-datacenter traffic received at the edge router.

Furthermore, the method also comprises enabling by the gateway server [300], the edge router to assign a minimum bandwidth and a maximum bandwidth to a marked priority. More particularly, the method encompasses enabling by the gateway server [300], the edge router to assign to a priority assigned to each type of inter-datacenter traffic (for instance ‘CALLPATH_REPLICATION’, ‘NON-CALLPATH REPLICATION’ etc.), a respective minimum bandwidth and a respective maximum bandwidth to enable traffic shaping. More specifically, the maximum bandwidths are allocated in an order of priorities, such that an inter datacenter traffic with highest priority is first allocated with a maximum bandwidth from a bandwidth available after fulfilling a minimum bandwidth requirement of all priorities. Thereafter, an inter datacenter traffic with a second highest priority (i.e. the second highest priority in an order of highest to lowest priorities) will be allocated with a maximum bandwidth from a bandwidth available after fulfilling maximum bandwidth requirement of the inter datacenter traffic with highest priority. This process of allocation of maximum bandwidth continues in the order of highest to lowest priorities till an allocation of a maximum bandwidth to an inter datacenter traffic associated with a lowest priority or till no bandwidth is available for a lower priority inter datacenter traffic after fulfilling maximum bandwidth requirement of an inter datacenter traffic with a higher priority inter datacenter traffic. Therefore, minimum bandwidths are always guaranteed for each marked priority (i.e. for ‘CALLPATH_REPLICATION’, ‘NON-CALLPATH REPLICATION’ etc. priorities) which helps to avoid starvation for data transmission. Similarly, maximum bandwidth that is allocated in the order of priorities for each marked priority (i.e. for ‘CALLPATH_REPLICATION’, ‘NON-CALLPATH REPLICATION’ etc. priorities) helps to allocate the maximum bandwidths for said each marked priority when a network has some additional bandwidth to use.

After shaping the inter-datacenter traffic by the gateway server [300] via the edge router, the method terminates at step [514].

Thus, the present invention provides a novel solution for dynamically shaping an inter-datacenter traffic. Also, based on the implementation of the features of the present invention, a priority in inter-datacenter data packets is marked accurately by using eBPF XDP techstack and an inter-DC bandwidth utilization is improved and a smooth experience is provided to users by enabling traffic shaping at one or more edge routers. Also, the present invention provides a solution where each priority bucket (or a priority assigned to each type of inter-datacenter traffic) is given a minimum and maximum bandwidths to enable traffic shaping. Therefore, minimum bandwidths are always guaranteed for each priority which helps to avoid starvation for data transmission. Similarly, maximum bandwidth allocated for each priority helps to allocate the maximum bandwidths for each priority when a network has some additional bandwidth to use. Also, based on the implementation of the features of the present invention millions of inter-datacenter data packets can be marked dynamically per second using eBPF XDP techstack and without any requirement of huge footprint of machines to mark the inter-datacenter data packets at this scale. Therefore, the present invention provides a technical advancement over currently known solutions at least by marking per second a priority to millions of inter-datacenter data packets and with very small set of machines.

### Performance Results

In currently known solutions IPTables are being used for packet marking and the present invention encompasses use of eBPF XDP techstack to enable packet marking in data packets. An experimental setup has been established to compare the performance of the eBPF XDP techstack and IPTables, wherein a traffic is being redirected to a receiver through a gateway server using IPIP tunnels. Here, gateway server is equipped with 25 Gbps NIC which means that it can process up to 25 Gb data per second. This gateway server has been configured with network policies to mark the data packets of the traffic. All IPTable policies are designed optimally to evaluate data packet(s) against as few policies as possible. The data packets are evaluated based on a source IP address first. If there is any matching rule based on the source IP address, it will be jumped to another chain to check based on a destination IP address. As per the assumptions in the currently known solutions, a data packet has to be evaluated against 2500 rules. In the case of eBPF XDP techstack, eBPF maps have been used to store policies/application flow policies where around 4 Lakh rules/policies are configured. When the eBPF maps are used to identify a priority of a data packet based on the implementation of the features of the present invention, the data packet has to make at most 4 lookups in the eBPF maps, which is considerably less as compared to the 2500 rules that are required to be evaluated in the prior known solution. Therefore considerable amount of resources can be saved by using the present invention.

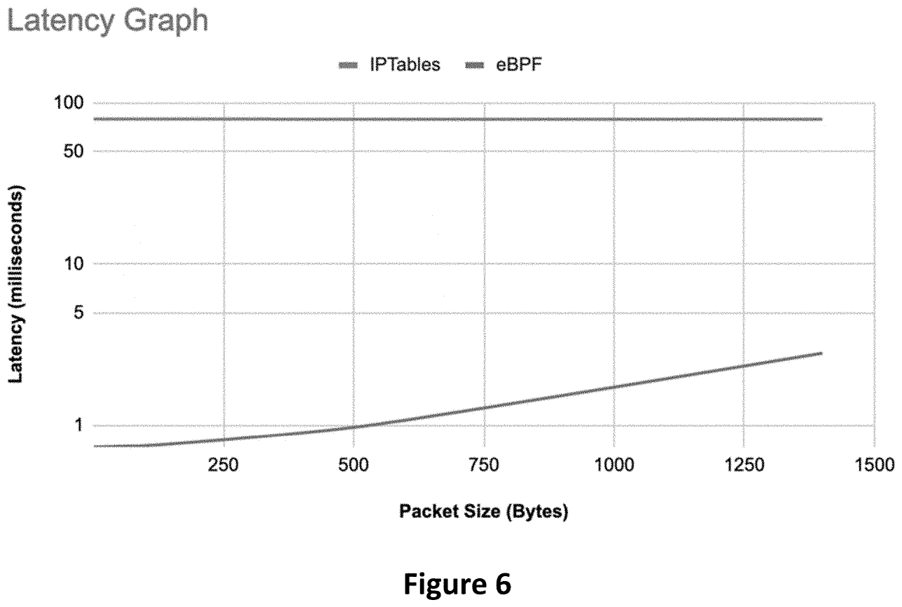

Further, a latency comparison between the IPTables and the eBPF XDP techstack is depicted in FIG. 6. FIG. 6 depicts that a latency of data packets from a sender to a receiver is 100 times higher when IPTables are used compared to eBPF XDP techstack. This indicates that IPTables take more time to process network policies compared to the eBPF XDP techstack. Also, FIG. 6 depicts that latency is slightly increased with packet size in case of the eBPF XDP techstack and remains same irrespective of packet size in case of IPTables.

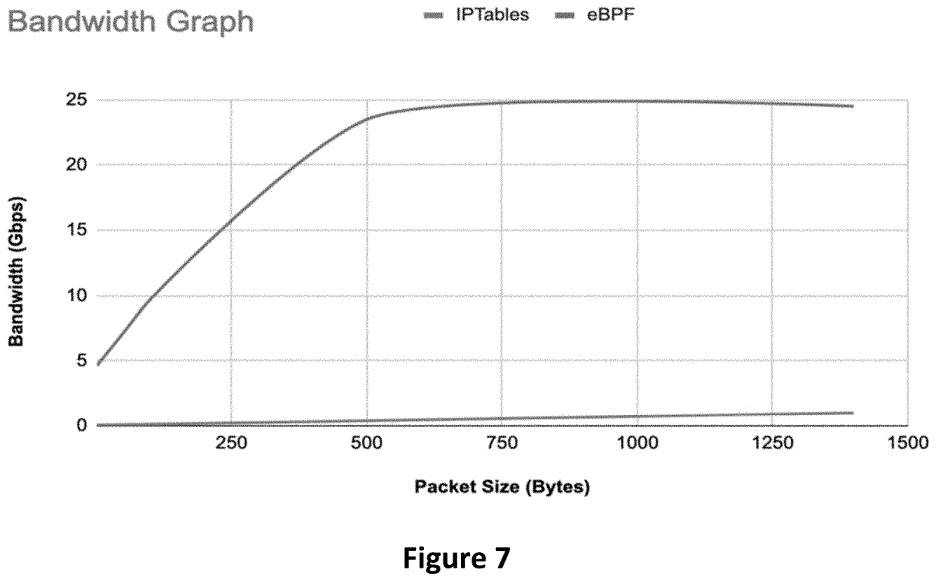

Further, FIG. 7 depicts that a bandwidth consumption of eBPF XDP techstack is limited by NIC capacity (25 Gbps). When the IPTables are configured, the bandwidth consumption is not even crossing the 1 Gbps.

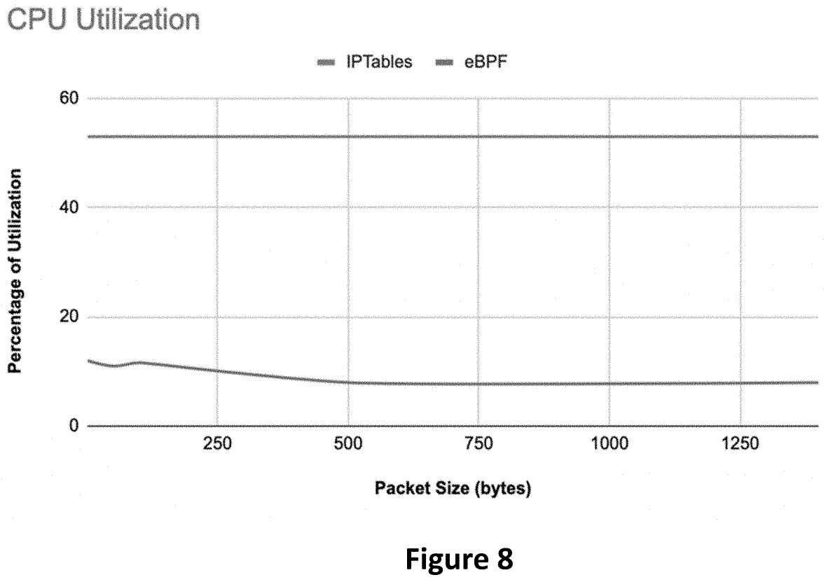

Further, FIG. 8 depicts that a CPU utilization of the eBPF XDP techstack is significantly lower compared to the IPTables.

As per the results, IPTables requires a huge number of machines to process a few hundred Gbps of data and adds huge latency to process data packet which is not acceptable in production environments. Hence, demonstrating the benefits of eBPF XDP techstack based packet processing.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for dynamically shaping an inter-datacenter traffic, the method comprising:
receiving, at a gateway server [300], one or more inter-datacenter data packets of the inter-datacenter traffic, wherein each inter-datacenter data packet from the one or more inter-datacenter data packets is associated with at least one of a corresponding application and a corresponding application interaction;
identifying, by the gateway server [300], one or more target application flow policies for said each inter-datacenter data packet from one or more application flow policies pre-stored in one or more eBPF maps for one or more inter-datacenter data packets associated with at least one of one or more applications and one or more application interactions;
dynamically marking, by the gateway server [300], a priority for said each inter-datacenter data packet using an eBPF (extended Berkeley Packet Filter) XDP (eXpress Data Path) techstack, based at least on the identified one or more target application flow policies of said each inter-datacenter data packet;
transmitting, from the gateway server [300] to an edge router, said each inter-datacenter data packet with the corresponding marked priority; and
dynamically shaping, by the gateway server [300] via the edge router, the inter-datacenter traffic based on said each inter-datacenter data packet and the corresponding marked priority of said each inter-datacenter data packet.

2. The method as claimed in claim 1, wherein dynamically marking, by the gateway server [300], a priority for said each inter-datacenter data packet using an eBPF XDP techstack further comprises marking a type of service (TOS) value in an IP header of said each inter-datacenter data packet.

3. The method as claimed in claim 2, wherein dynamically marking, by the gateway server [300], a priority for said each inter-datacenter data packet using an eBPF XDP techstack is further based on at least one of a source detail, a destination detail, and a protocol detail associated with said each inter-datacenter data packet.

4. The method as claimed in claim 2, wherein dynamically shaping, by the gateway server [300] via the edge router, the inter-datacenter traffic is further based on the TOS value marked in the IP header of said each inter-datacenter data packet.

5. The method as claimed in claim 1, wherein the inter-datacenter traffic is one of an Infrastructure traffic type, a Call Path Traffic type, Call-Path Replication traffic type, Non-Call-Path Replication traffic type, and a Bulk traffic type.

6. The method as claimed in claim 5, wherein dynamically marking, by the gateway server [300], a priority for said each inter-datacenter data packet using an eBPF XDP techstack is further based on a type of inter-datacenter traffic associated with said each inter-datacenter data packet.

7. The method as claimed in claim 1, wherein the one or more application flow policies pre-stored in the one or more eBPF maps are associated with one or more application flow priorities of at least one of the one or more applications and the one or more application interactions.

8. The method as claimed in claim 7, wherein the one or more application flow priorities of at least one of the one or more applications and the one or more application interactions are based on a grouping of a plurality of network elements associated with at least one of the one or more applications and the one or more application interactions.

9. The method as claimed in claim 7, wherein the method further comprises updating in real time the one or more application flow policies pre-stored in the one or more eBPF maps based on at least one of a source network group detail, a destination network group detail, a destination port detail, a protocol detail, and a priority detail associated with the one or more inter-datacenter data packets associated with at least one of the one or more applications and the one or more interactions.

10. The method as claimed in claim 9, wherein the method further comprises updating in real time the one or more eBPF maps based on the updated one or more application flow policies pre-stored in the one or more eBPF maps.

11. A gateway server [300] for dynamically shaping an inter-datacenter traffic, the gateway server [300] comprising:
a transceiver unit [302] configured to receive one or more inter-datacenter data packets of the inter-datacenter traffic, wherein each inter-datacenter data packet from the one or more inter-datacenter data packets is associated with at least one of a corresponding application and a corresponding application interaction;
an identification unit [304] configured to identify one or more target application flow policies for said each inter-datacenter data packet from one or more application flow policies pre-stored in one or more eBPF maps for one or more inter-datacenter data packets associated with at least one of one or more applications and one or more application interactions; and
a processing unit [306] configured to dynamically mark a priority for said each inter-datacenter data packet using an eBPF (extended Berkeley Packet Filter) XDP (eXpress Data Path) techstack based at least on the identified one or more target application flow policies of said each inter-datacenter data packet, wherein:
the transceiver unit [302] is further configured to transmit to an edge router said each inter-datacenter data packet with the corresponding marked priority, and
the processing unit [306] is further configured to dynamically shape via the edge router the inter-datacenter traffic based on said each inter-datacenter data packet and the corresponding marked priority of said each inter-datacenter data packet.

12. The gateway server [300] as claimed in claim 11, wherein the processing unit [306] is further configured to mark a type of service (TOS)) value in an IP header of said each inter-datacenter data packet using the eBPF XDP techstack to dynamically mark the priority for said each inter-datacenter data packet.

13. The gateway server [300] as claimed in claim 11, wherein dynamically marking the priority for said each inter-datacenter data packet is based on at least one of a source detail, a destination detail, and a protocol detail associated with said each inter-datacenter data packet.

14. The gateway server [300] as claimed in claim 12, wherein the processing unit [306] is further configured to dynamically shape via the edge router the inter-datacenter traffic based on the TOS value marked in the IP header of said each inter-datacenter data packet.

15. The gateway server [300] as claimed in claim 11, wherein the inter-datacenter traffic is one of a Infrastructure traffic type, a Call Path Traffic type, Call-Path Replication traffic type, Non-Call-Path Replication traffic type, and a Bulk traffic type.

16. The gateway server [300] as claimed in claim 15, wherein dynamically marking the priority for said each inter-datacenter data packet is further based on a type of inter-datacenter traffic associated with said each inter-datacenter data packet.

17. The gateway server [300] as claimed in claim 11, wherein the one or more application flow policies pre-stored in the one or more eBPF maps are associated with one or more application flow priorities of at least one of the one or more applications and the one or more application interactions.

18. The gateway server [300] as claimed in claim 17, wherein the one or more application flow priorities of at least one of the one or more applications and the one or more application interactions are based on a grouping of a plurality of network elements associated with at least one of the one or more applications and the one or more application interactions.

19. The gateway server [300] as claimed in claim 17, wherein the processing unit [306] is further configured to update in real time the one or more application flow policies pre-stored in the one or more eBPF maps based on at least one of a source network group detail, a destination network group detail, a destination port detail, a protocol detail, and a priority detail associated with the one or more inter-datacenter data packets associated with at least one of the one or more applications and the one or more application interactions.

20. The gateway server [300] as claimed in claim 19, wherein the processing unit [306] is further configured to update in real time the one or more eBPF maps based on the updated one or more application flow policies pre-stored in the one or more eBPF maps.
